(19) United States
(12) Patent Application Publication
(10) Pub. No.: US 2025/0107536 A1
(43) Pub. Date: Apr. 3, 2025

(54) DEVICE AND METHOD FOR SHAPING FOOD, INCLUDING DOUGH

(71) Applicants: Kenneth Michael Buckley, Lachine (CA); Jean-Francois Defoy, Lachine (CA); Peter Josef Heilmann, Lachine (CA)

(72) Inventors: Kenneth Michael Buckley, Lachine (CA); Jean-Francois Defoy, Lachine (CA); Peter Josef Heilmann, Lachine (CA)

(21) Appl. No.: 18/833,095

(22) PCT Filed: Feb. 4, 2023
(86) PCT No.: PCT/IB2023/051000

§ 371 Date: Jul. 25, 2024

Related U.S. Application Data
(60) Provisional application No. 63/307,539, filed on Feb. 7, 2022.

(51) Int. Cl. A21C 11/00

(52) U.S. Cl. CPC A21C 11/006

(57) ABSTRACT

A food press is described. The food press includes a first unit, a moveable drawer, a pressing mechanism, and a base unit. The moveable drawer is lifted by the pressing mechanism away from the base unit and towards the first unit.

This application claims priority to U.S. Provisional Application Ser. No. 63/307,539, filed Feb. 7, 2022, presently pending, the contents of which are now incorporated by reference.

### BACKGROUND OF THE INVENTION

### 1. Field of the Invention

The invention is a device and method for shaping food, including dough, specifically for forming a portion of an arbitrary shape with a consistent thickness using a process that is repeatable and occurs subsequently to manipulation of the food or dough.

### 2. Background of the Invention

Pliable or formable food, such as dough, has traditionally been shaped by using manual techniques. However, acquiring skills in these techniques is time-consuming and generally requires training by an expert. For example, handmade pizza crusts can be made in the desired shape (e.g., circular) with a consistent thickness, but only by an expert, and even an experienced cook cannot guarantee consistent output.

Various automated machines exist for dough shaping on an industrial scale, for example, at a food processing plant. However, such assembly-line machines cannot be used in a setting other than a food processing plant. Settings such as restaurants, wholesale clubs, grocery stores, cafeterias in institutions, cruise ships, or other commissary-based production lines are all potential settings that would benefit from a high-efficiency dough press.

In prior art approaches, smaller form factor machines will use flattening plates, often pivoting around a single hinge or multiple hinges. Such machines generally require ample amounts of oil to be added before the dough is pressed out. Furthermore, such machines apply heat to the food, resulting in partial cooking which must be scraped off regularly. In prior art devices, a pivoting function is a solution that allows access to clean the upper plate. Machines with a pivoting hinge action do not apply pressure consistently, resulting in uneven dough. Prior art pivoting arm presses have an inherent design issue which results in misalignment at the pivot bushing being multiplied by the distance from the center of the force. Over time, this causes the gap to be uneven from left to right, and dough extrudes out. The embodiment described herein not only eliminates any rotational force but also does not place any load on the movement mechanism at all due to the design, ensuring that an even force is applied consistently throughout the pressing process.

A need exists in the art for a device to form consistent food without relying on plates joined by pivoting hinges, heat, or the addition of oil. A need also exists for a method of using and manufacturing such a device.

### SUMMARY OF INVENTION

An object of the invention is to provide a device for pressing dough to form shapes that are consistent and repeatable. A feature of the invention is that it allows for the pressing of dough with consistent pressure being applied between a surface and without the addition of oil or another lubricant. An advantage of the invention is that it provides a dough press that is reliable and easy to maintain.

Another object of the invention is to provide a machine for pressing dough that is reliable. A feature of the invention is that the machine does not use a pivoting hinge between pressing plates and instead uses an extending drawer with a pressing action completely independent of the extension feature in one embodiment. An advantage of the invention is that it avoids a common point of failure in other devices, and the movement mechanism is not exposed to the load during the pressing operation.

### BRIEF DESCRIPTION OF THE DRAWINGS

The invention, together with the above and other objects and advantages, will be best understood from the following detailed description of the preferred embodiment of the invention shown in the accompanying drawings, wherein:

FIG. 1 depicts an overview of one embodiment of the invention;

FIG. 2A depicts a side view of one embodiment in an open configuration;

FIG. 2B depicts a side view of one embodiment in a closed configuration;

FIG. 2C depicts a top view of one embodiment;

FIG. 2D depicts a front view of one embodiment;

FIG. 2E depicts a top view of an embodiment;

FIG. 3 depicts the details of the drawer component of one embodiment;

FIGS. 4A-4C depict the details of a press plate component of one embodiment; and

FIG. 5 depicts a diagram of a method of use of one embodiment.

### DETAILED DESCRIPTION OF THE INVENTION

The previous summary and the following detailed description of specific embodiments of the present invention will be better understood when read in conjunction with the appended drawings.

As used herein, an element or step recited in the singular and proceeded with the word “a” or “an” should be understood as not excluding plural said elements or steps unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As described herein, the device is described as being used to shape dough, but is suitable for manipulation of any other item that can benefit from pressing, both food and non-food. For example, the device can be used to tenderize meats, crush ice, crush spices, and other food-grade applications.

### Overview of Device

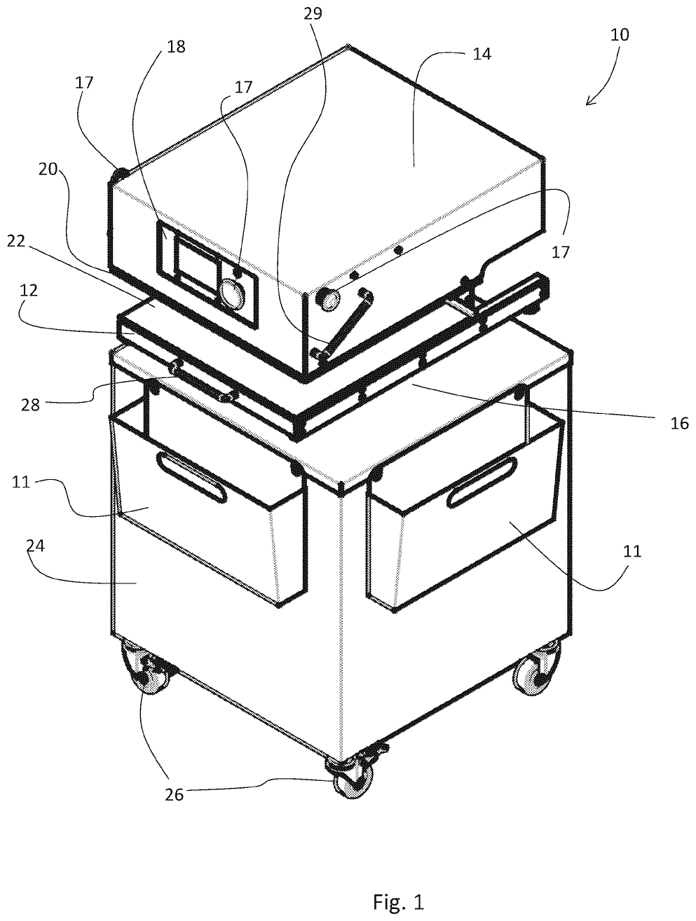

Turning to the figures, FIG. 1 depicts a schematic of an embodiment of the food press device 10. The food press device 10 comprises a moveable element such as a drawer 12, a stationary element such as a first unit 14, and a base unit 24. While not visible in FIG. 1, the first unit 14 is attached to or joined with the base unit 24 on at least one side of the first unit 14 and base unit 24. The attachment is depicted in subsequent figures.

The base unit 24 includes a cover surface 16 through which a lifting or pressing mechanism extends (not visible in FIG. 1) and a set of optional wheels 26 on the opposing side of the base unit 24. The details of the pressing mechanism are discussed below. In one embodiment, the pressing mechanism moves the drawer 12 and its assembly so that it contacts the first unit 14. The first unit 14 includes a control panel 18. An interior surface of the first unit 14 is covered by a first unit press plate 20. The drawer 12 also includes a corresponding drawer press plate 22. The details of each component will be described below.

Briefly, in use, the pressing mechanism is set to a resting position such that a space is created between the first unit press plate 20 and the drawer press plate 22. In one configuration of an embodiment, the gap between the first unit press plate 20 and the drawer press plate 22 is at least four inches or another distance suitable to enable cleaning and inspection of the first unit press plate 20 and the drawer press plate 22. The gap is adapted to provide enough space to facilitate the cleaning of both plates 20, 22.

The drawer 12 is then extended, for example, by pulling on the handle 28. The dough or food is placed on the drawer press plate 22 and the drawer 12 is pushed back towards the food press device 10. The control panel 18 functions to begin the pressing process are enabled, and the drawer press plate 22 is lifted to the first unit press plate 20 by the pressing mechanism. The lifting of the drawer press plate 22 does not expose the extension mechanism of the drawer to the load of the lifting and the extension mechanism is not load bearing during the pressing of the drawer 12 or other moveable element. The food press device 10 does not use pivoting plates connected by one or more pivoting hinges. The motion of the moveable element such as the drawer 12 in the food press device 10 to load is in the horizontal plane while the pressing or lifting action occurs in the vertical plane. Pivoting action is not used.

For safety reasons, in one embodiment, the food press device 10 require a two-hand operation. In one embodiment, the food press device 10 includes three potential actuation switches 17. Two buttons or switches 17 shown on the front top corners of the first unit 14 must be engaged and held simultaneously to ensure the operators' hands are protected away from the pressing plates 20, 22. In this way, the device 10 can eliminate other guards around the press plates 20, 22 and ensures that the press plates 20, 22 are easily accessible. In one embodiment, the switches 17 must be pressed, in other embodiments the switches 17 must be pulled out. In yet another embodiment, the switches 17 comprise touch sensitive areas. Finally, in some embodiments, the switches 17 include a biometric sensor, such as a fingerprint reader, to make sure the same authorized person is engaging both switches.

The first unit 14 includes movement handles 29 on opposite sides of the first unit, in some embodiments. The movement handles 29 keep hands away from the pressing areas of the food press device 10 and ensure that the movement is controlled and the machine does not tip over. The handles 29 for moving the unit are located strategically as an additional safety component.

The food or dough on the drawer press plate 22 is then flattened by the action of the pressing mechanism. The weight is evenly distributed across the drawer press plate 22, resulting in a flattened food or dough with a consistent thickness, in one embodiment, having a substantially round shape. In one embodiment, the round shape has a diameter of up to 18 inches and a consistent thickness.

In another embodiment, the drawer press plate 22 or the first unit press plate 20 includes a shaping pattern (not shown) defined therein. The shaping pattern results in the pressed food having a different shape than a round, such as a rectangle. The shaping pattern is adapted to introduce a texture to the food, in some embodiments. The pressing mechanism then lowers the drawer press plate 22, and the drawer 12 can once again be extended away from the food press device 10. The pressed food can then be retrieved.

In one embodiment, the drawer press plate 22 does not include a shaping pattern. Instead, the shape of the pressed food is controlled by the initial shape of the food or dough placed on the drawer press plate 22. For example, if the initial shape is spherical, the pressed food will have a round shape. However, if the initial shape is a an elongated cuboid, a roll, or cylindrical, the pressed food will have a rectangular shape.

As shown in FIG. 1, the embodiment of the food press device 10 accommodates a variety of additional accessories. For example, in one embodiment, the food press device 10 includes containers 11 extending on the sides of the base unit 24. The containers 11 can be used to collect waste in one embodiment. The food press device 10 embodiment shown in FIG. 1 is exemplary and other embodiments are possible. For example, in another embodiment, the food press device is implemented as a countertop version. Also, while in FIG. 1 the drawer press plate 22 moves up and towards the first unit press plate 20, in other embodiments, the first unit press plate 20 moves down to the drawer press plate 22 instead.

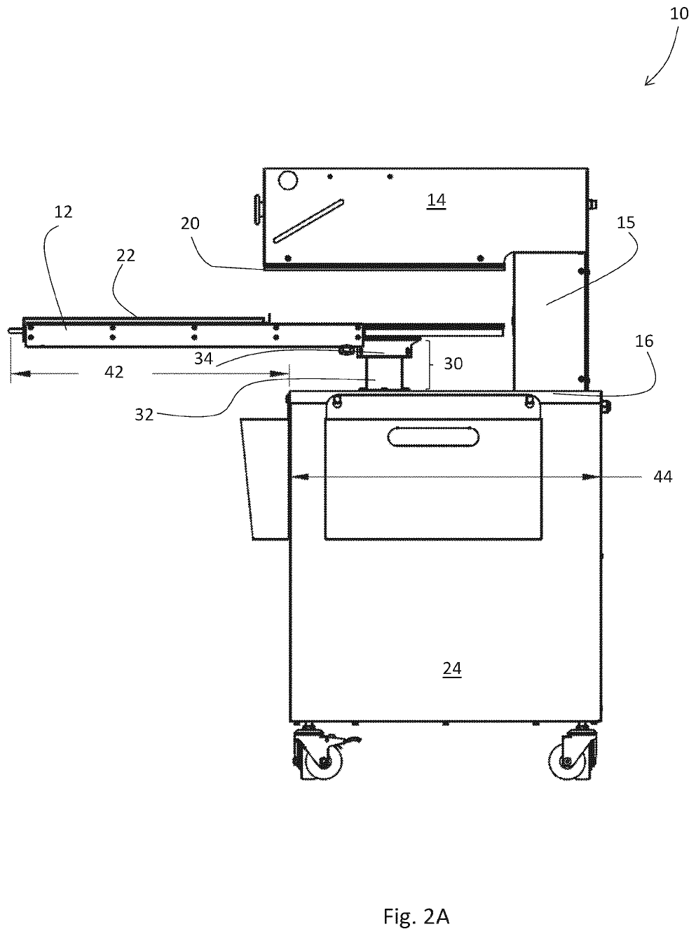

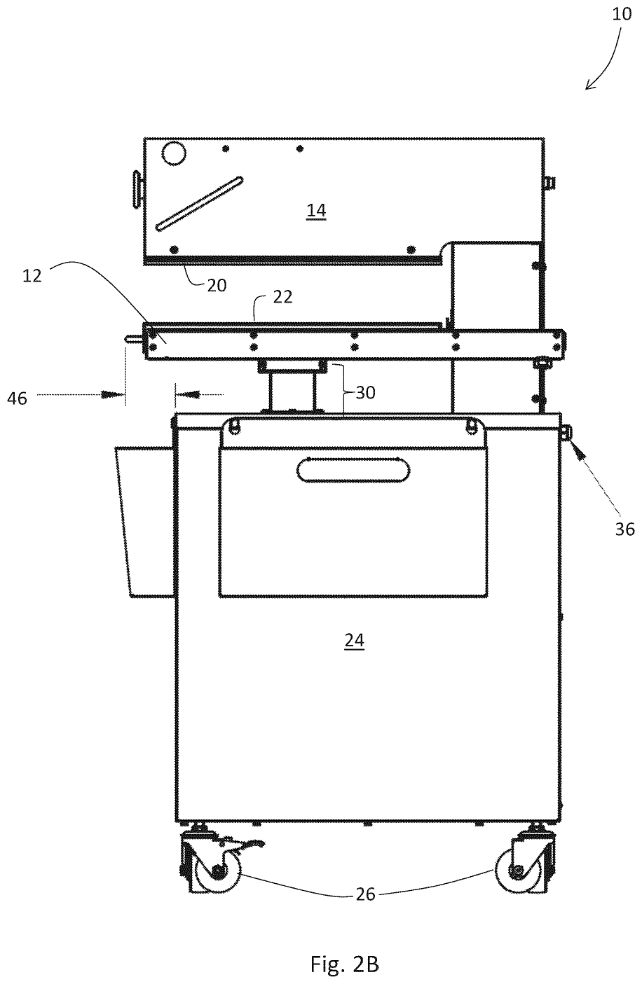

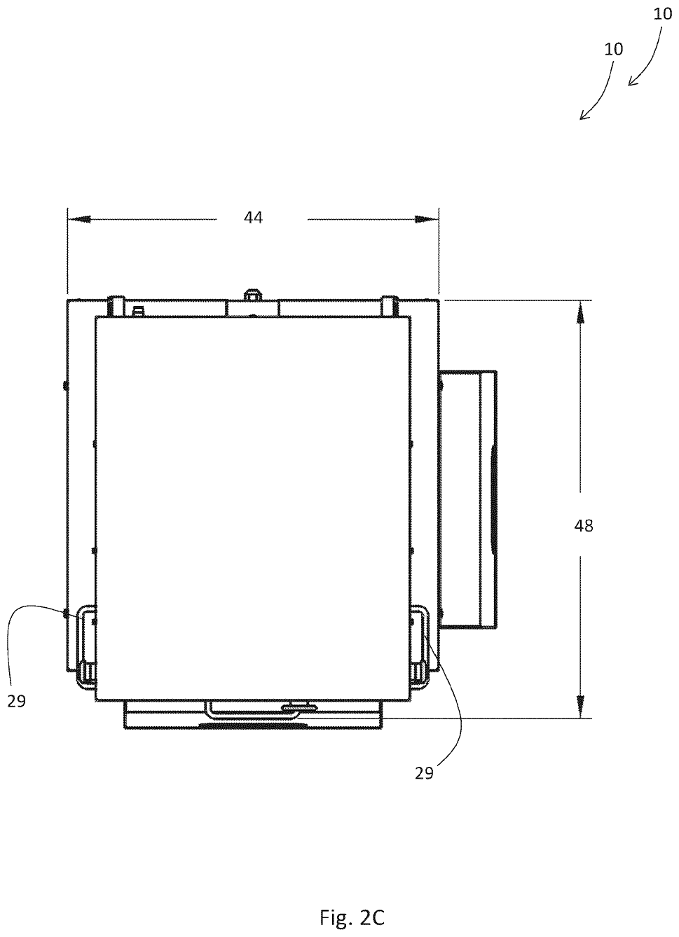

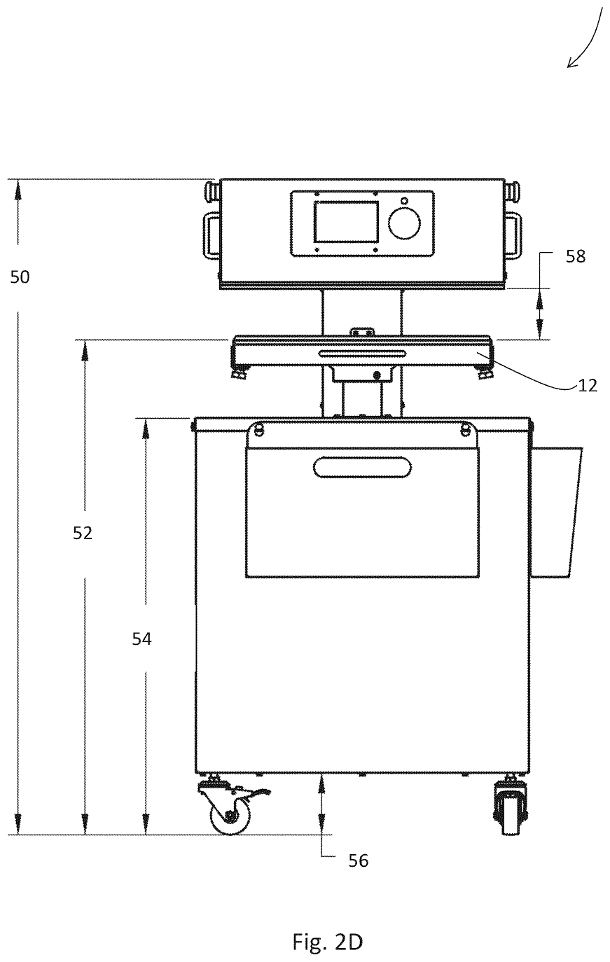

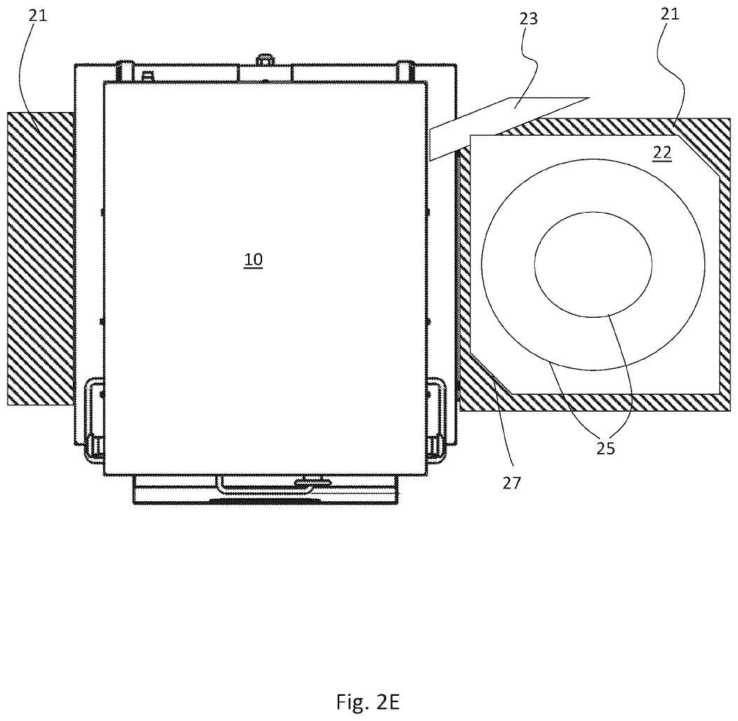

FIG. 2A is a side view of the food press device 10, showing the drawer 12 extended. Visible in FIG. 2A is the support pillar 15, which connects the first unit 14 to the base unit 24. The support pillar 15, the first unit 14, and the base unit 24 form a “C” frame design. Also visible in FIG. 2A is the pressing mechanism 30 comprising a hydraulically controlled ram 32 of a hydraulic jack attached to a receptacle 34 on the underside of the drawer 12.

The support pillar 15 is designed to counteract the force exerted on the drawer 12 by the pressing mechanism 30. In one embodiment, the ram 32 applies as much as 1½ tons of pressure on the drawer 12. In other embodiments, a different pressing mechanism 30 is used, which applies a lesser amount of force. For example, in a countertop embodiment, the pressing mechanism 30 comprises a manually-actuated jack, for example, a jackscrew mechanism operated by a leadscrew. In one embodiment, the movement of the leadscrew is manual, while in other embodiments the pressing mechanism 30 is driven by a motor.

As can be seen in FIG. 2A, the drawer 12 includes a working area defined by the drawer press plate 22.

The extension distance 42 of the drawer 12 is approximately 23.25 inches, while the width 44 of the base unit 24 is approximately 26 inches. In one embodiment, the distance 42 is 23 and 3/16 inches.

While FIG. 2A shows the drawer 12 extending away from the front of the base unit 24, the drawer can move in an arbitrary direction away from the base unit 24. In one embodiment, the pressing mechanism 30 and receptacle 34 includes a direction selection mechanism that controls the direction of extension of the drawer 12 away from the base unit 24. For example, in one embodiment the drawer extends to the side of the base unit 24. In another embodiment, the drawer 12 extends at a diagonal direction away from the base unit 24. The direction of extension of drawer 12 is dictated by the placement of the food press device 10 within a particular kitchen setting.

In at least one embodiment, the drawer 12 is automatically extended once the pressing action is concluded, especially if the drawer 12 is extending in a direction other than the front of the base unit 24 where the operator is standing. The extension of the drawer 12 allows the operator to examine the pressed food and add other Ingredients, if appropriate, before retrieving the pressed food from the drawer press plate 22.

FIG. 2B shows the drawer 12 in a retracted configuration where the drawer press plate 22 and the first unit press plate 20 are in substantial alignment such that if the pressing mechanism 30 were to lift the drawer 12 towards the first unit 14, the two press plates 20, 22 would come in contact, flattening any food on the drawer press plate 22. The lifting of the drawer 12 and pressing the drawer against the first unit 14 exerts pressure on the drawer press plate 22 and the first unit press plate 20 and not the remaining components of the drawer 12 which are on the periphery of the drawer 12. The components responsible for the extension of the drawer 12, described herein, are not exposed to the pressure exerted on the drawer press plate 22, even though the drawer 12 is the component that is moving towards the first unit 14. No heat is added to the drawer press plate 22 or the first unit press plate 20 during the pressing.

FIG. 2B also shows the power receptacle 36 on the base unit 24. In one embodiment, the food press device 10 operates on common power sources, such as 110V/240V power, requiring no more than fifteen amps of current from a 110V outlet. The food press device 10 is portable in that in some embodiments, it includes wheels 26 and can use power from a common power outlet. With the drawer retracted, the distance 46 is only about 3.5 inches, in one embodiment, the distance 46 is 3⅜ inches. The absence of protruding features allows the food press device 10 to be stored efficiently while not in use.

FIGS. 2C and 2D are a top view and a front-side view of one embodiment of the food press device 10 showing various measurements to emphasize how the device is portable and can be accommodated in any kitchen. FIG. 2C shows the width 44 of the device is approximately 26 inches, and the depth 48 is approximately 30 inches. In one embodiment, the depth 48 is 29 and ⅜ inches. As the top view, FIG. 2C shows both moving handles 29.

FIG. 2D shows various measurements from the front of the embodiment of the food press device 10. The total height 50 of the embodiment of the food press device 10 is approximately 51 inches, for example, 50 and 31/32 inches in one embodiment. The drawer height 52 is approximately 38.5 inches, in an embodiment the drawer height 52 is 38 and 15/32 inches. The height of the base 54 is approximately 32.5 inches, in one embodiment the height of the base 54 is 32 and 13/32 inches. The wheel height 56 is approximately 4.75 inches or 4 and 27/32 inches in one embodiment. The clearance between the drawer and the first unit 58 is approximately 4 inches when the drawer 12 is in a lowered configuration, as shown in FIG. 2D.

While the embodiment shown above is depicted as a stand-alone unit, in other embodiments, the dough press device is implemented as a table-top unit. In yet other embodiments, the device is permanently attached to the floor rather than using the wheels depicted in the figures discussed above.

In further embodiments, such as the embodiment shown in FIG. 2E, the food press device 10 is used in conjunction with a conveyor system 21. The conveyor system 21 carries drawer press plate 22 which are received by the food press device 10 and then the conveyor system 21 takes the drawer press plate 22 from food press device 10 once the dough is pressed. The food press device 10 includes an arm 23 to position each drawer press plate 22 as it arrives by the food press device 10. While the embodiment of FIG. 2E shows the drawer press plate 22 as a removable element, in other embodiments conveyor system 21 delivers food to be processed to a food press device 10 with fixed press plates. The food is then transferred to a press plate at the food press device 10.

In one embodiment, the food press device 10 is used in conjunction with other food dispensers or devices. For example, the embodiment shown in FIG. 2E can be used with an ingredient dispenser arm, such as a sauce dispenser arm (not shown). After the food or dough is pressed to the desired shape, the press plate 22 moves to a second station where the next ingredient, such as sauce, is added to the pressed food or dough. To facilitate the dispensing of ingredients, the press plate 22 includes one or more rotatable sections 25, which rotate independently of the press plate 22 and one another. The rotatable sections 25 allow the pressed food to rotate while the dispensing arm remains stationary or moves in only one direction, for example, extending over the entirety of the pressed food and then slowly retracting as the food rotates. This creates a swirl pattern of the dispensed ingredient, for example sauce for a pizza.

In one embodiment, the press plate 22 includes an alignment feature to Identify the orientation of the press plate 22, such as notched corner 27 shown in FIG. 2E.

The conveyor system 21 can move the press plate 22 to multiple ingredient stations and dispensers, as needed. For example, in another station, cheese is added to the dough and sauce combination. In another station, the ingredient dispenser arm dispenses ingredients such as pizza toppings.

While the above description relies on the conveyor system 21 to move the pressed pizza to multiple stations, in one embodiment, a multi-purpose ingredient dispenser is integrated into a stand-alone unit, such as the food press 10 shown in FIG. 2A. The ingredient arm can reach the pressed food while the pressing mechanism 30 is disengaged or while the drawer 12 is extended. The ingredient dispenser arm is coupled to the first unit 14 in one embodiment and is controlled by the control panel 18. In such embodiments, the food press device 10 functions as a stand-alone food assembly tool, with varying levels of automation. For example, in one embodiment, the ingredient dispenser is manually positioned by the operator. In another embodiment, the ingredient dispenser is automatically controlled by a combination of electronics built into the food press device 10 and an external computer, such as a distributed artificial intelligence system for controlling the alignment and operation of the food dispenser arm.

### Drawer Details

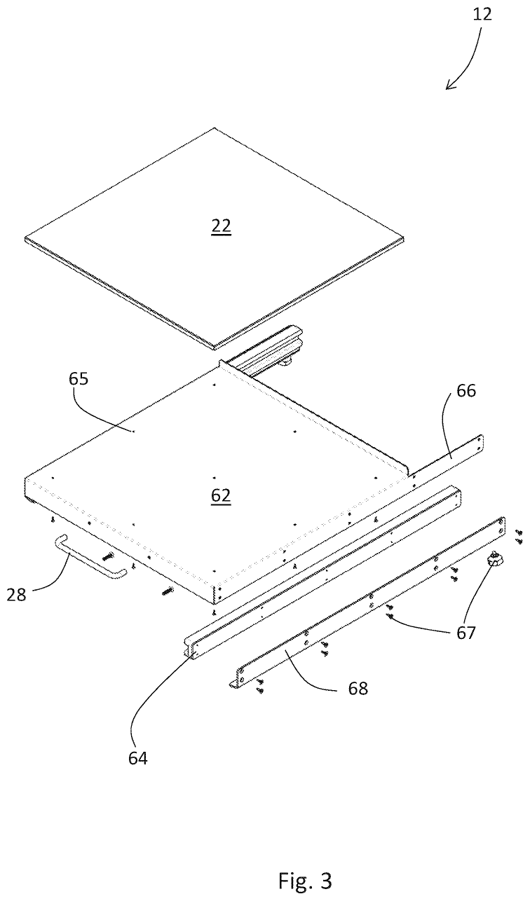

The details of the drawer 12 are shown in the exploded view of FIG. 3. The drawer 12 comprises the drawer press plate 22, a base 62 and rails 64. The rails 64 slidably receive arms 66 of the base 62 such that the drawer 12 can move along the rails 64, which are received by brackets 68. The entire assembly slides in and out together, in one embodiment. The base unit shown in previous figures receives drawer 12.

The drawer handle 28 is attached to the base 62. All of the components are attached together using appropriate fasteners 67, as shown in FIG. 3. In one embodiment, the drawer press plate 22 includes alignment protrusions (not visible in FIG. 3), which are received by the openings 65 in the base 62. The openings 65 in the base 62 comprise apertures having smooth walls. In other embodiments, the openings 65 are designed to receive threaded fasteners, such as screws. In some embodiments, the openings 65 are defined only in the surface of the base 62, while in other embodiments, the openings 65 are through-holes in the base 62 allowing for fasteners from the underside of the drawer press plate 22 to extend through the base 62.

In the embodiments depicted in earlier figures, the entirety of the drawer 12 move during the pressing action, not just the drawer press plate 22 or a only a portion of the drawer press plate 22. The design of the drawer is such that the force exerted on the drawer press plate 22 is not transferred to rails 64 and other components on the periphery of the base 62.

### Press Plate Details

As shown in the figures, such as in FIG. 1, the first unit 14 has a first unit press plate 20 while the drawer 12 has a drawer press plate 22. The selection of the material for the press plates 20, 22 is of critical importance. The material should result in consistent rounds of food, including dough, and should be capable of pressing out the food without the addition of heat or oil. The surface cannot be too smooth, nor can the surface be too rough. It must be capable of handling food or dough of varying consistencies, such as rising pizza dough or pie crusts, breads, and so on.

As the pressure applied to the press plates 20, 22 is high, exceeding one ton in one embodiment, the press plates must comprise a material that allows for non-destructive deformation. The food will also undergo both elastic and plastic deformation. Plastic deformation occurs when compression applied to the food exceeds its yield strength and causes the food to be pressed out and is generally not reversed when the pressure is removed. Elastic deformation is generally temporary and is reversed after removal of the force.

After trying many alternative food-grade materials, the food press device 10 uses an HDPE material for press plates 20, 22 including Sanalite material available from Mitsubishi Chemical Advanced Materials.

In some embodiments, the press plates 20, 22 include a material with a smooth surface, such as press plates 20, 22 having a non-stick coating (polytetrafluoroethylene or Teflon, for example). In other embodiments, the press plates 20, 22 comprise a heavyweight plastic material, such as ultra-high molecular weight polyethylene (UHMW) with a textured finish adapted to release the type of dough or food being pressed.

A benefit of the Sanalite material is that the final finish can be customized. In one embodiment, the surface finish and texture are customized to optimize the flow of food during pressing. In one embodiment, the first unit press plate 20, which remains stationary, has lower friction than the drawer press plate 22, which is mobile. This way, the food will not stick to the first unit press plate 20 after pressing.

The use of Sanalite material obviates the need for adding oil during pressing of food. Prior art pressing devices require regular application of oil, which spreads throughout the work area, requiring frequent cleanup. The current device does not require this addition.

Further, while prior art devices will heat up the pressing surfaces or require the covering of the pressing surfaces with a friction-reducing plastic, no such consumables are required in the current device, in part due to the use of Sanalite.

However, other food-grade and food-safe materials are also compatible with the drawer arrangement. For example, in one embodiment, a coated metal plate is used. Further, engineered composite materials are used in other embodiments. In further other embodiments, a plate coated with Teflon is used.

In one embodiment, the first unit press plate 20 has a thickness of % of an inch while the drawer press plate 22 has a lower thickness of ⅜ of an inch. In other embodiments, each pressing plate 20, 22 has a common thickness. The thickness is adapted to allow for some deformation during use, but will not result in cracking.

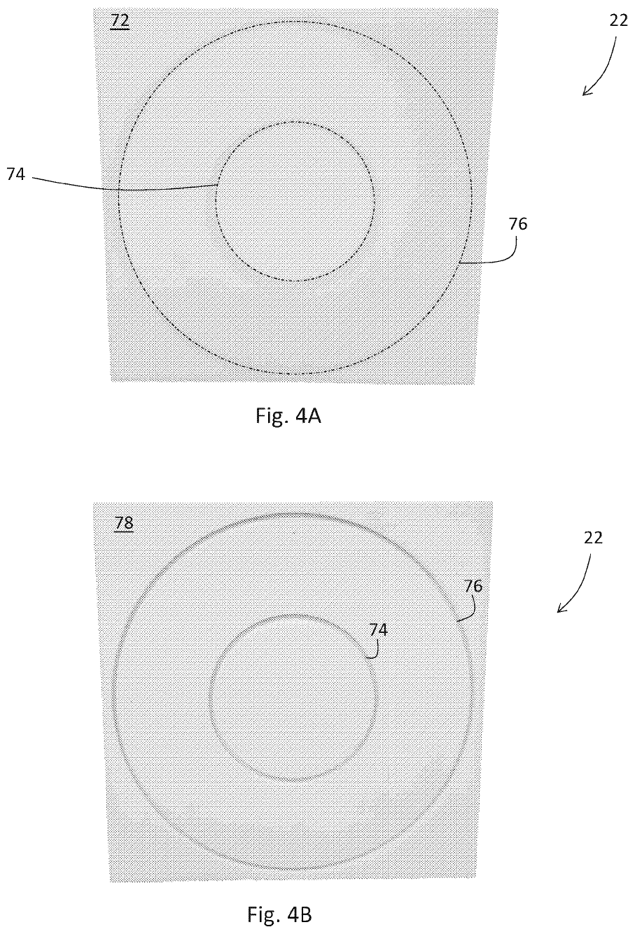

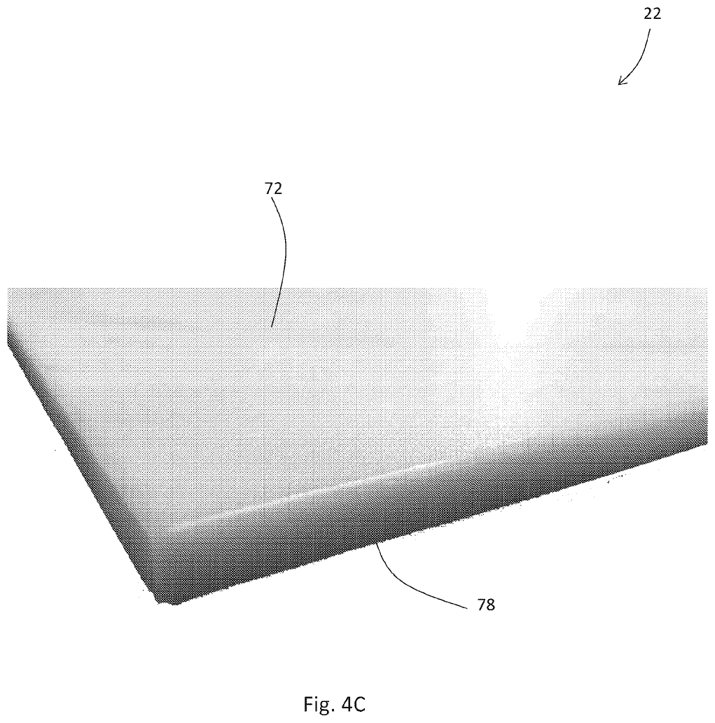

FIG. 4A depicts a photograph top view of one embodiment of the drawer press plate 22. In one embodiment, the drawer press plate 22 is rectangular or square. The version shown in FIG. 4A is somewhat trapezoidal due to the angle of the camera. The press plate has a main body operator side 72 and two visible circles—an inner circle 74 and an outer circle 76. Dotted lines are added in FIG. 4A, only for clarity. The inner circle 74 is a target from the operator side 72 to place the food and spread it out to the boundaries of the inner circle 74 prior to pressing. The outer circle 76 is scribed at the desired finished diameter of the product to provide the operator with a visual go/no-go gauge to determine if any adjustments are required.

The machine side 78 is depicted in FIG. 4B. As can be seen in FIG. 4B, the inner circle 74 and outer circle 76 are scribed into the machine side 78. In this way, the operator side 72 has a completely smooth surface with no ink or other additives. FIG. 4C shows the surface texture of the drawer press plate 22 with the operator side 72 visible. The machine side 78 is on the opposite side of the operator side 72.

As explained above, the final finish on the first unit press plate 20 varies from the drawer press plate 22, to achieve a difference in friction coefficients, in most embodiments.

In most embodiments, the drawer press plate 22 or the first unit press plate 20 or both are replaceable by the end user. For example, each press plate may wear down with use, or a different press plate may be desirable for use with a different types of food or dough. For example, to maintain organic status, an end user may have designated press plates that are only used for food with only organic ingredients. As described above, some press plates may have shaping features to facilitate pressing of shapes other than round ones. The end user of the press plates may then interchange the press plates. In such an embodiment, the press plates include one or more attachment points on the underside of the press plate, such as fasteners protruding from the surface of the underside, which are then secured to the first unit or drawer.

In one embodiment, the drawer press plate 22 includes a receptacle for a removable cooking pan, such as a pizza pan. This eliminates the need to retrieve the pressed food from the face of the press plate 22. In one embodiment, the press plate 22 includes a magnetic element and the cooking pan comprises a metallic construction which is attracted to the magnetic element embedded int eh press plate 22.

In at least some embodiments, the drawer press plate 22 or the first unit press plate 20 includes surface features to mold the final shape of the food or dough after pressing. The drawer press plate 22 or first unit press plate 20 can include guiding markings or channels and other surface features to impart a particular shape to the dough once it is pressed. In one embodiment, the drawer press plate 22 includes guides for cutting the dough with a cutting tool, such as target markings or a pattern that the operator cuts out of the dough.

### Method of Use

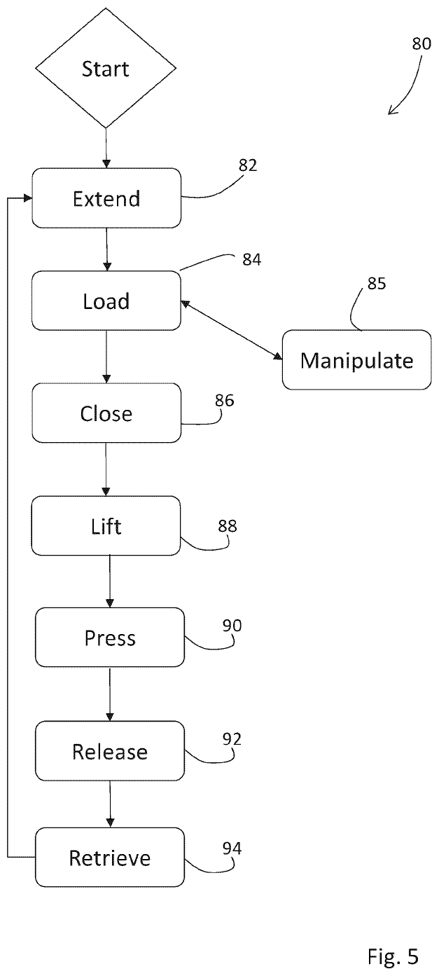

A method of use 80 is shown in FIG. 5. The method begins by extending the drawer 82. The food or dough to be pressed is then loaded on the drawer 84. The food can optionally be manipulated 85 when it is loaded on the drawer by, for example, partially spreading it out prior to pressing. The drawer is then closed 86. The pressing mechanism is actuated 88. The food is then pressed out into the required pattern 90. The pressing mechanism is released 92, and the pressed food can be retrieved from the drawer 94. As part of the retrieval step, the pressed food can be trimmed as the drawer press plate is a suitable cutting surface. In one embodiment, the cutting occurs using a cutter having a shape other than a round.

The process can then restart with the next batch of food after wiping. The drawer and the first unit are sufficiently separated to facilitate efficient cleaning, by for example maintaining a clearance of at least 4 inches.

In one embodiment, one pressing can occur as quickly as % A of a second to 4.5 seconds. No additives are required, such as oil or heat.

The material of the pressing plate is sufficiently resilient that final steps with sharp implements can be performed on the food while it remains on the press plate. For example, docking of dough can be performed prior to removal.

The steps above are carried out by a human operator, in one embodiment and by a robotic arm having sufficient freedom of movement in another embodiment. In a partially automated embodiment, an automated extruder extrudes the dough placed on the drawer from a larger container in one embodiment. None of the steps require large amounts of force to be applied, nor do they have to be performed with complete precision. In some embodiments, the processes are a combination of manual work and automated tasks. For example, placement of the dough is done by an automated extruder, in one embodiment, to ensure a consistent amount of dough is place on the drawer.

While the above steps generally refer to dough, the same process can be used with other food items, such as meat. For example, the device can be used to press meat to tenderize it.

Also, while some embodiments are adapted for pressing of pizza dough and other dough to be baked, the device can be used to press other types of dough, including pastry dough, pasta dough, bread dough, and a myriad of other types of food.

Although exemplary implementations of the invention have been depicted and described in detail herein, it will be apparent to those skilled in the relevant art that various modifications, additions, substitutions, and the like can be made without departing from the spirit of the invention. These are therefore considered to be within the scope of the invention as defined in the following claims.

It is to be understood that the above description is intended to be illustrative and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the invention parameters, they are by no means limiting but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The embodiment of the invention in which an exclusive property or privilege is claimed is defined as follows:

1. A food press comprising:
a stationary element;
a moveable element;
a pressing mechanism; and
a base unit;
wherein the moveable element is moved by the pressing mechanism away from the base unit and towards the stationary element.

2. The food press of claim 1 wherein said moveable element comprises a drawer.

3. The food press of claim 2 wherein said drawer extends away from the food press during loading.

4. The food press of claim 1 wherein said stationary element comprises a first unit.

5. The food press of claim 1 wherein said moveable element comprises a moveable drawer and the stationary element comprises a first unit.

6. The food press of claim 5 further comprising:
a first unit press plate attached to the first unit;
a drawer press plate attached to the moveable drawer;
where said first unit press plate and said drawer press plate comprise food-grade materials.

7. The food press of claim 6 wherein said food-grade materials comprise an HDPE material.

8. The food press of claim 7 wherein said HDPE material comprises Sanalite.

9. The food press of claim 1 further comprising wheels.

10. The food press of claim 1 wherein said food press excludes pivoting hinges.

11. The food press of claim 1 wherein said pressing mechanism further comprises a safety switch requiring use of both hands to operate.

12. The food press of claim 6 wherein said drawer press plate comprises shaping features.

13. The food press of claim 6 wherein said first unit press plate comprises shaping features.

14. The food press of claim 1 wherein said stationary element comprises a drawer and said moveable element comprises a first unit.

15. The food press of claim 1 wherein said stationary element is connected to the base.

16. The food press of claim 1 wherein a connection between the stationary element and the base unit comprises a pillar.

17. The food press of claim 1 wherein said pressing mechanism comprises a hydraulic jack.

18. The food press of claim 1 wherein said pressing mechanism comprises a manually-actuated jack.

19. The food press of claim 1 further comprising an extension mechanism for the moveable element and said extension mechanism is not load-bearing during actuation of the pressing mechanism.

20. A method of using the food press of claim 1 wherein said food comprises dough and oil is not added during pressing of dough.
